(19) United States
(12) Patent Application Publication
(10) Pub. No.: US 2019/0255888 A1
(43) Pub. Date: Aug. 22, 2019

(54) PNEUMATIC TIRE

(71) Applicant: Toyo Tire Corporation, Itami-shi (JP)

(72) Inventor: Jiro Taniguchi, Itami-shi (JP)

(73) Assignee: Toyo Tire Corporation, Itami-shi (JP)

(21) Appl. No.: 16/266,431

(22) Filed: Feb. 4, 2019

(30) Foreign Application Priority Data
Feb. 21, 2018 (JP) 2018-028818

(51) Int. Cl. B60C 11/01

(52) U.S. Cl. CPC B60C 11/01; B60C 2200/14

(57) ABSTRACT

A pneumatic tire includes a tread portion, a sidewall portion, a buttress portion provided between the tread portion and the sidewall portion, multiple first protrusions provided to the buttress portion and spaced in a tire circumferential direction, and multiple second protrusions provided to the buttress portion in spaces between the first protrusions situated adjacently in the tire circumferential direction. The first protrusions have a larger area of top surfaces than the second protrusions and a higher protruding height from the buttress portion than the second protrusions. The second protrusions are provided with recessed grooves that sink below top surfaces.

### FIELD OF THE INVENTION

The present invention relates to a pneumatic tire.

### BACKGROUND ART

A technique to provide a pneumatic tire designed for rough road traveling with multiple protrusions spaced in a tire circumferential direction in a buttress portion formed between a tread portion and a sidewall portion is disclosed in, for example, JP-A-2004-291937, JP-A-2004-291938, and JP-A-2018-1942. The protrusions are provided to generate traction by shear resistance when the tire sinks in a muddy ground for a purpose to ensure driving performance in the muddy ground. The protrusions also enhance resistance to external damage incurred by rough road traveling.

According to the three patent literatures specified above, driving performance in the muddy ground and resistance to external damage can be enhanced by providing the protrusions over a broad range in the buttress portion. However, when the protrusions are provided over a broad range, mud often remains in spaces among the protrusions, which may possibly cause significant deterioration in the driving performance.

### SUMMARY OF THE INVENTION

The present invention has an object to provide a pneumatic tire achieving enhanced driving performance in a muddy ground and enhanced resistance to external damage, and hardly causing deterioration in driving performance caused by deposition of mud due to a capability of readily discharging mud deposited in spaces among protrusions.

A pneumatic tire of the present invention includes a tread portion, a sidewall portion, a buttress portion provided between the tread portion and the sidewall portion, multiple first protrusions provided to the buttress portion and spaced in a tire circumferential direction, and multiple second protrusions provided to the buttress portion in spaces between the first protrusions situated adjacently in the tire circumferential direction. The first protrusions have a larger area of top surfaces than the second protrusions and a higher protruding height from the buttress portion than the second protrusions. The second protrusions are provided with recessed grooves that sink below top surfaces.

### BRIEF DESCRIPTION OF THE DRAWINGS

FIG. 1 is a partial perspective view of a pneumatic tire according to a first embodiment of the present invention;

FIG. 2 is a half sectional perspective view of the pneumatic tire of FIG. 1;

FIG. 3 is a developed view of a tread portion and a buttress portion of the pneumatic tire of FIG. 1;

FIG. 4 is an enlarged view of a major portion of FIG. 3;

FIG. 5 is a sectional view taken along the line A-A of FIG. 4; and

FIG. 6 is a sectional view taken along the line B-B of FIG. 4.

### DESCRIPTION OF THE PREFERRED EMBODIMENT

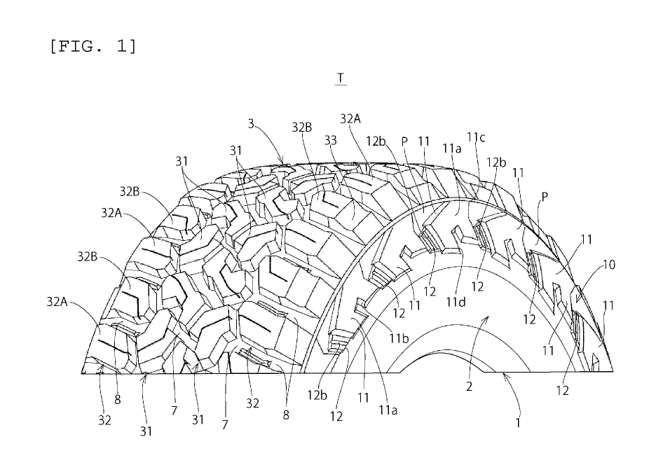

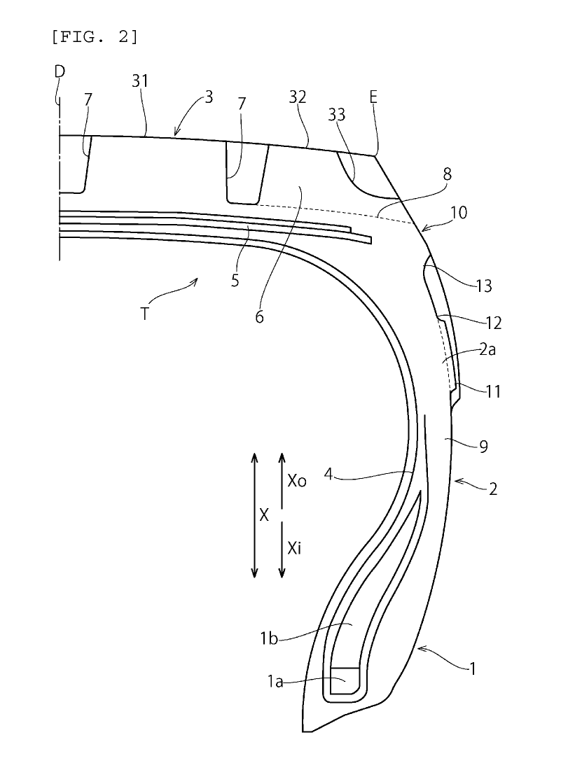

Hereinafter, one embodiment of the present invention will be described with reference to the drawings. FIG. 1 is a partial perspective view showing one example of a pneumatic tire T according to the present embodiment. FIG. 2 is a tire meridional cross section of the pneumatic tire T. Only the right half of the pneumatic tire T is shown in FIG. 2.

The pneumatic tire T is an off-road pneumatic tire designed to travel a rough road including a rocky ground and a muddy ground. The pneumatic tire T includes a pair of right and left bead portions 1, a pair of right and left sidewall portions 2 extending in an outward-pointing tire radial direction Xo from the respective bead portions 1, a tread portion 3 continuing to outer ends of the respective sidewall portions 2 in a tire radial direction X, and a pair of right and left buttress portions 10 disposed at positions in an inward-pointing tire radial direction Xi when viewed from the tread portion 3. The buttress portion 10 is a boundary region between the sidewall portion 2 and the tread portion 3 and provided so as to connect the sidewall portion 2 and the tread portion 3.

The bead portion 1 is provided with an annular bead core 1a and a bead filler 1b. A toroidal carcass 4 is provided between a pair of the bead portions 1.

The carcass 4 extends from the tread portion 3 to the respective bead portions 1 by way of the buttress portions 10 and the sidewall portions 2 and is locked by the bead cores 1a. Hence, the carcass 4 reinforces the respective portions 1, 2, 3, and 10. Herein, both ends of the carcass 4 are folded around the respective bead cores 1a from inside to outside in a tire width direction to lock the carcass 4. An inner liner to maintain an air pressure is provided on an inner side of the carcass 4.

The carcass 4 is formed of at least one ply which includes organic fiber or steel cords aligned at a predetermined angle (for example, 70° to 90°) with respect to a tire circumferential direction Y and covered with topping rubber. Herein, the carcass 4 is formed of one ply. Examples of the organic fiber cords used preferably to form the carcass 4 include but not limited to polyester fiber, rayon fiber, aramid fiber, and nylon fiber.

In the sidewall portion 2, sidewall rubber 9 is provided to an outer side of the carcass 4 (that is, to a tire outer surface).

In the tread portion 3, a belt 5 formed of two plies layered as inner and outer layers is disposed along an outer periphery of the carcass 4. Further, tread rubber 6 is provided along an outer periphery of the belt 5. The belt 5 includes one or more than one steel belt layer formed of steel cords aligned at an angle of 10 to 65 degrees with respect to the tire circumferential direction Y. Herein, the belt 5 includes two steel belt layers.

The tread portion 3 includes multiple blocks defined by circumferential grooves 7 which extend while bending in a zigzag manner along the tire circumferential direction Y on a surface of the tread rubber 6 and lateral grooves 8 which extend while crossing the circumferential grooves 7.

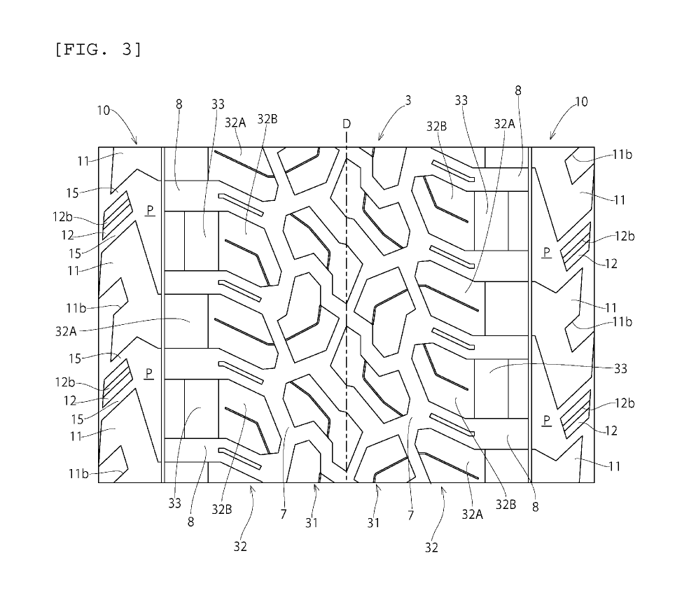

Herein, as is shown in FIG. 3, the tread portion 3 has a total of four block lines: a pair of center block lines 31 located on both sides of a tire equatorial plane D and a pair of shoulder block lines 32 located in shoulder regions on both sides of the center block lines 31. In each shoulder block line 32, a first shoulder block 32A and a second shoulder block 32B provided with a recess 33 at an outer end in the tire width direction are disposed alternately in the tire circumferential direction Y. The first shoulder block 32A and the second shoulder block 32B are divided in the tire circumferential direction Y by the lateral grooves 8 that open to side surfaces of the tread portion 3. It should be appreciated, however, that a tread pattern of a pneumatic tire of the present invention is not particularly limited.

In the shoulder block lines 32, outer ends of tread surfaces in the tire width direction form tread contact ends which connect to the buttress portions 10 extending in the inward-pointing tire radial direction Xi and forming top portions of the tire side surfaces.

An outer wall surface 10a of the buttress portion 10 is provided with multiple first protrusions 11 spaced in the tire circumferential direction Y and multiple second protrusions 12 each disposed between two first protrusions 11 situated adjacently in the tire circumferential direction Y.

Both of the first protrusions 11 and the second protrusions 12 are bumps rising from the outer wall surface 10a of the buttress portion 10. The first protrusions 11 and the second protrusions 12 are provided to the outer wall surface 10a of the buttress portion 10 in such a manner that top surfaces 11a of the first protrusions 11 occupy a larger area than top surfaces 12a of the second protrusions 12.

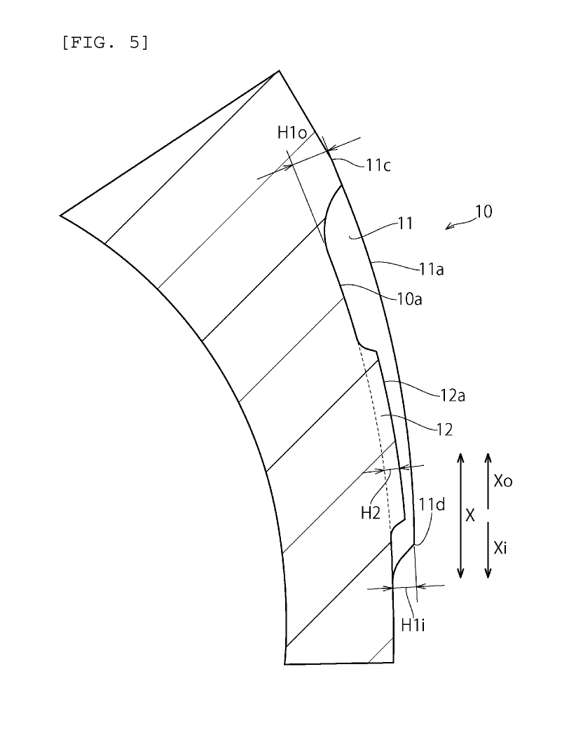

A protruding height of the first protrusions 11 from the outer wall surface 10a of the buttress portion 10 increases gradually in the outward-pointing tire radial direction Xo. That is, a protruding height H1o of the first protrusions 11 from the outer wall surface 10a of the buttress portion 10 at an outer end 11c in the tire radial direction X is set higher than a protruding height H1i of the first protrusions 11 at an inner end 11d in the tire radial direction X. Also, the protruding heights H1o and H1i of the first protrusions 11 from the outer wall surface 10a of the buttress portion 10 are set higher than a protruding height H2 of the second protrusions 12 (see FIG. 5).

The second protrusion 12 is disposed between two first protrusions 11 situated adjacently in the tire circumferential direction Y and spaced apart from the both first protrusions 11 in the tire circumferential direction Y. A space defined by the first protrusions 11 and the second protrusion 12 forms a first recessed groove 15 which forms a part of the outer wall surface 10a of the buttress portion 10.

The second protrusion 12 is provided with a second recessed groove 12b which sinks below the top surface 12a. The second recessed groove 12b is provided along the tire radial direction X to open to an inner wall 12c and an outer wall 12d of the second protrusion 12 in the tire radial direction X. The phrase, “the second recessed groove 12b along the tire radial direction X”, means not only the second recessed groove 12b extending parallel to the tire radial direction X, but also the second recessed groove 12b extending in a direction inclined with respect to the tire radial direction X.

A depth (a length from the top surface 12a of the second protrusion 12 to a bottom of the second recessed groove 12b) D of the second recessed groove 12b provided to the second protrusion 12 is set to be less than the protruding height H2 of the second protrusion 12. That is, the bottom of the second recessed groove 12b rises above the outer wall surface 10a of the buttress portion 10.

In the present embodiment, the first protrusions 11 and the second protrusions 12 are disposed to make a space P surrounded by two first protrusions 11 situated adjacently in the tire circumferential direction Y and one second protrusion 12 provided therebetween overlaps the lateral grooves 8 and the second shoulder block 32B provided to the tread portion 3 in the tire circumferential direction Y. That is, the space P is disposed at a position in the inward-pointing tire radial direction Xi when viewed from the lateral grooves 8 and the second shoulder block 32B. Meanwhile, the first protrusion 11 is disposed at a position in the inward-pointing tire radial direction Xi when viewed from the first shoulder block 32A.

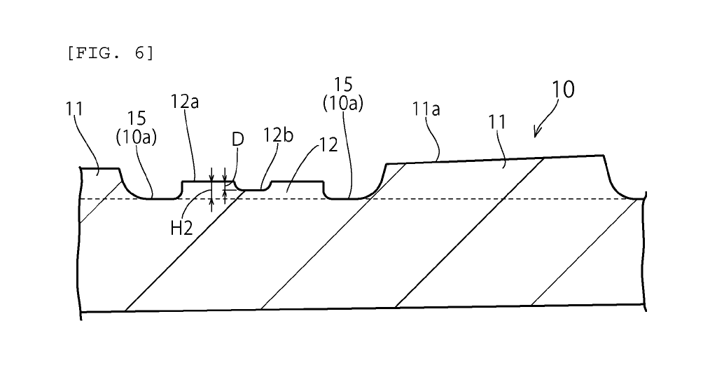

An example of dimensions of the first protrusion 11 and the second protrusion 12 will now be described with reference to FIG. 5 and FIG. 6. That is, the protruding height H1o of the first protrusion 11 from the outer wall surface 10a of the buttress portion 10 at the outer end 11c in the tire radial direction X can be set to 5 to 10 mm. The protruding height H1i of the first protrusion 11 from the outer wall surface 10a of the buttress portion 10 at the inner end 11d in the tire radial direction X can be set to 3 to 7 mm. The protruding height H2 of the second protrusion 12 from the outer wall surface 10a of the buttress portion 10 can be set to 2 to 3 mm. The depth D of the second recessed groove 12b provided to the second protrusion 12 can be set to 1 to 2 mm.

Herein, the respective dimensions specified above are dimensions in a normal condition in which a pneumatic tire attached to a normal rim is filled to a normal internal pressure under no load unless specified otherwise. The term, “a contact end”, referred to herein means an end of the tread surface in the tire width direction in contact with a road surface in a normal load condition in which a pneumatic tire attached to a normal rim and filled to a normal internal pressure is placed perpendicularly on a flat road surface under a normal load.

The term, “a normal rim”, means a rim specified for each tire according to standards of a tire in question in gauge systems including the standards of the tire. For example, a normal rim means a standard rim according to JATMA, a design rim according to TRA, and a measuring rim according to ETRTO. The term, “a normal internal pressure”, means an air pressure specified for each tire according to respective standards in the gauge systems including standards of a tire in question. A normal internal pressure means a maximum air pressure according to JATMA, a maximum value set forth in a table of tire load limits at various cold inflation pressures according to TRA, and an inflation pressure according to ETRTO. The term, “a normal load”, means a load specified for each tire according to respective standards in the gauge systems including standards of a tire in question. A normal load means a maximum load capability according to JATMA, a maximum value set forth in the table above according to TRA, and a load capacity according to ETRTO.

The outer wall surface 10a of the buttress portion 10 means an outer wall surface portion of a main body of the buttress portion 10 except for the first protrusions 11 and the second protrusions 12, and is normally of a shape of a meridional cross section formed by smoothly connecting multiple arcs.

According to the pneumatic tire T of the present embodiment as above, not only can driving performance in the muddy ground and resistance to external damage be enhanced, but also deterioration in driving performance caused by deposition of mud can be limited due to a capability of readily discharging mud deposited in spaces among the first protrusions 11 and the second protrusions 12.

That is, the pneumatic tire T sinks into a soft ground, such as a muddy ground, due to a weight of the vehicle, in which case the first protrusions 11 buried in the mud make pseudo-contact with the ground. Accordingly, traction is generated at the first protrusions 11 as the pneumatic tire T rolls. Driving performance in the muddy ground can be thus enhanced.

The second protrusion 12 protruding less than the first protrusions 11 is provided between two first protrusions 11 situated adjacently and spaced in the tire circumferential direction Y. Hence, high traction can be obtained by trapping the mud in a space formed between the two first protrusions 11 situated adjacently in the tire circumferential direction Y. At the same time, the space between two first protrusions 11 can be protected by the second protrusion 12. Moreover, an amount of rubber required for the pneumatic tire T can be smaller than in a case where the second protrusions 12 and the first protrusions 11 are formed at the same protruding height.

In the present embodiment, the second protrusion 12 is provided with the second recessed groove 12b. Owing to this configuration, even when mud deposits in a space between two first protrusions 11 situated adjacently in the tire circumferential direction Y, the mud dries later and easily starts to fall off from the second recessed groove 12b as the pneumatic tire T undergoes deformation. Deterioration in driving performance caused by mud deposited in a space between the first protrusions 11 can be thus prevented.

In the present embodiment, the protruding height of the first protrusion 11 from the outer wall surface 10a of the buttress portion 10 gradually increases in the outward-pointing tire radial direction Xo. Hence, traction generated at the first protrusion 11 while the pneumatic tire T rolls can be increased, which can in turn further enhance the driving performance in the muddy ground.

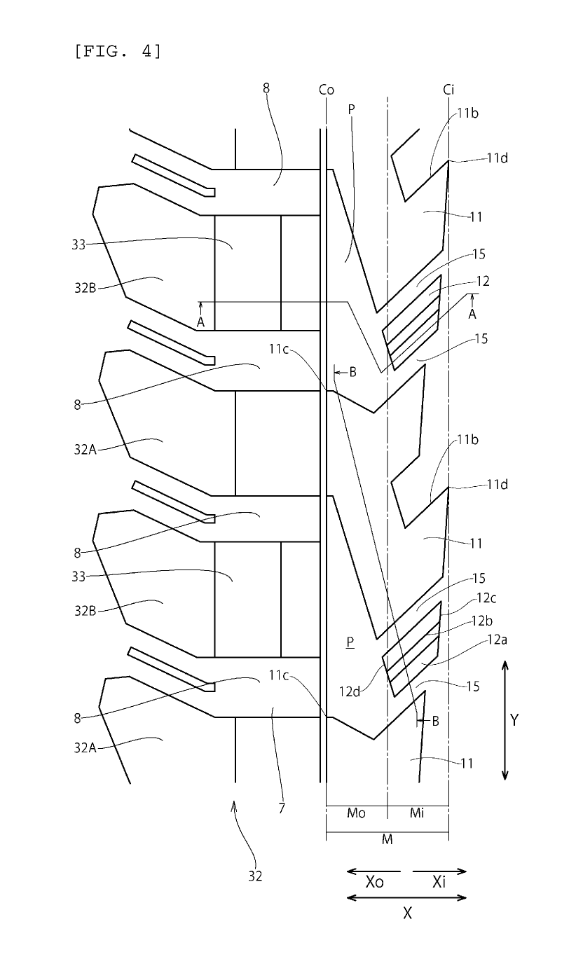

In the present embodiment, as are shown in FIG. 3 and FIG. 4, a notch 11b opening to at least one side in the tire radial direction X (herein, the side located in the inward-pointing tire radial direction Xi) may be provided to the first protrusion 11. By providing the notch 11b to the first protrusion 11, larger traction can be generated at the first protrusion 11 when the pneumatic tire T sinks into the muddy ground, which can in turn further enhance the driving performance in the muddy ground.

In the present embodiment, a proportion of the first protrusions 11 and the second protrusions 12 to the outer wall surface 10a of the buttress portion 10 can be set arbitrarily. However, as is shown in FIG. 4, a ratio of a total area of the top surfaces 11a of the first protrusions 11 and the top surfaces 12a of the second protrusions 12 preferably accounts for 50% or more of an area of a region M sandwiched between an outer circle Co passing outermost points of the first protrusions 11 and the second protrusions 12 in the tire radial direction X (herein, the outer end 11c of the first protrusion 11 in the tire radial direction X) and an inner circle Ci passing innermost points in the tire radial direction X (herein, the inner end 11d of the first protrusion 11 in the tire radial direction X).

By providing the first protrusions 11 and the second protrusions 12 in this manner, high resistance to external damage can be ensured in the buttress portion 10.

In the present embodiment, when the region M sandwiched between the outer circle Co and the inner circle Ci is halved to an inner region Mi and an outer region Mo each having an equal length in the tire radial direction X, an absolute value of a difference (=ri−ro) between a ratio ri of a total of an area Si1 of the top surfaces 11a of the first protrusions 11 and an area Si2 of the top surfaces 12a of the second protrusions 12 located in the inner region Mi to an area Si of the inner region Mi (=(Si1+Si2)/Si) and a ratio ro of a total of an area So1 of the top surfaces 11a of the first protrusions 11 and an area So2 of the top surfaces 12a of the second protrusions 12 located in the outer region Mo to an area So of the outer region Mo (=(So1+So2)/So) is preferably 15% or less.

By providing the first protrusions 11 and the second protrusion 12 in this manner, the buttress portion 10 can have substantially a constant rubber thickness in the tire radial direction X, which allows rubber to flow satisfactorily during tire vulcanization molding. Hence, moldability of the first protrusions 11 and the second protrusion 12 can be improved by limiting poor flowing of rubber.

The embodiment above has described a case where the protruding height of the first protrusion 11 from the outer wall surface 10a of the buttress portion 10 gradually increases in the outward-pointing tire radial direction Xo. However, the protruding height of the first protrusion 11 may remain constant across the top surface 11a of the first protrusion 11.

The first protrusions 11 and the second protrusions 12 are provided to at least one of a pair of the right and left buttress portions 10. However, it is preferable to provide the first protrusions 11 and the second protrusions 12 to the both buttress portions 10 in enhancing traction performance in the muddy ground and resistance to external damage.

A pneumatic tire of the present invention is same as a normal pneumatic tire except that the first protrusions 11 and the second protrusions 12 as described above are provided to the outer wall surface 10a of the buttress portion 10, and materials, shapes, structures, manufacturing methods known in the art are all applicable in the present invention.

While the above has described several embodiments of the present invention, it should be appreciated that the embodiments described above are mere examples and have no intention to limit the scope of the invention. The embodiments above can be implemented in various other manners and various omissions, replacements, changes can be made within the scope of the invention. The embodiments above and modifications thereof are included within the spirit and scope of the invention as well as inventions set forth in the claims below and equivalences.

What is claimed is:

1. A pneumatic tire, comprising:
a tread portion;
a sidewall portion;
a buttress portion provided between the tread portion and the sidewall portion;
multiple first protrusions provided to the buttress portion and spaced in a tire circumferential direction; and
multiple second protrusions provided to the buttress portion in spaces between the first protrusions situated adjacently in the tire circumferential direction, wherein:
the first protrusions have a larger area of top surfaces than the second protrusions and a higher protruding height from the buttress portion than the second protrusions; and
the second protrusions are provided with recessed grooves that sink below top surfaces.

2. The pneumatic tire according to claim 1, wherein:
the first protrusions are provided with notches which open in a tire radial direction.

3. The pneumatic tire according to claim 1, wherein:
when a region sandwiched between an outer circle passing outermost points of the first protrusions and the second protrusions in a tire radial direction and an inner circle passing innermost points in the tire radial direction is halved to an inner region and an outer region each having an equal length in the tire radial direction, a difference between a ratio of a total area of the top surfaces of the first protrusions and the second protrusions located in the inner region to an area of the inner region and a ratio of a total area of the top surfaces of the first protrusions and the second protrusions located in the outer region to an area of the outer region is 15% or less.

4. The pneumatic tire according to claim 1, wherein:
a ratio of a total area of the top surfaces of the first protrusions and the second protrusions accounts for 50% or more of an area of a region sandwiched between an outer circle passing outermost points of the first protrusions and the second protrusions in a tire radial direction and an inner circle passing innermost points in the tire radial direction.

5. The pneumatic tire according to claim 1, wherein:
the protruding height of the first protrusions from the buttress portion increases in an outward-pointing tire radial direction.

6. The pneumatic tire according to claim 2, wherein:
when a region sandwiched between an outer circle passing outermost points of the first protrusions and the second protrusions in the tire radial direction and an inner circle passing innermost points in the tire radial direction is halved to an inner region and an outer region each having an equal length in the tire radial direction, a difference between a ratio of a total area of the top surfaces of the first protrusions and the second protrusions located in the inner region to an area of the inner region and a ratio of a total area of the top surfaces of the first protrusions and the second protrusions located in the outer region to an area of the outer region is 15% or less.

7. The pneumatic tire according to claim 2, wherein:
a ratio of a total area of the top surfaces of the first protrusions and the second protrusions accounts for 50% or more of an area of a region sandwiched between an outer circle passing outermost points of the first protrusions and the second protrusions in the tire radial direction and an inner circle passing innermost points in the tire radial direction.

8. The pneumatic tire according to claim 3, wherein:
a ratio of a total area of the top surfaces of the first protrusions and the second protrusions accounts for 50% or more of an area of a region sandwiched between an outer circle passing outermost points of the first protrusions and the second protrusions in the tire radial direction and an inner circle passing innermost points in the tire radial direction.

9. The pneumatic tire according to claim 2, wherein:
the protruding height of the first protrusions from the buttress portion increases in an outward-pointing tire radial direction.

10. The pneumatic tire according to claim 3, wherein:
the protruding height of the first protrusions from the buttress portion increases in an outward-pointing tire radial direction.

11. The pneumatic tire according to claim 4, wherein:
the protruding height of the first protrusions from the buttress portion increases in an outward-pointing tire radial direction.
